(19) United States
(12) Patent Application Publication
(10) Pub. No.: US 2026/0249722 A1
(43) Pub. Date: Aug. 27, 2026

(54) SMART JUNCTION BOX FOR EV SMART BREAKER CHARGER INSTALLATION

(71) Applicant: EATON INTELLIGENT POWER LIMITED, DUBLIN 4 (IE)

(72) Inventors: Daniel J. Carnovale, Gibsonia, PA (US); Saivaraprasad Murahari, Peachtree City, GA (US)

(73) Assignee: EATON INTELLIGENT POWER LIMITED, DUBLIN 4 (IE)

(21) Appl. No.: 19/065,547

(22) Filed: Feb. 27, 2025

(51) Int. Cl. B60L 53/30; B60L 53/16; H02G 3/08; B60L 53/67

(52) U.S. Cl. CPC B60L 53/305; B60L 53/16; H02G 3/08; B60L 53/67

(57) ABSTRACT

A smart junction box for an improved EV charging system is disclosed. The improved EV charging system includes the smart junction box, an EV smart breaker (EVSB), and one or more standard junction boxes. The smart junction box comprises multiple switches and communication capability, and is structured to simultaneously be connected to the EVSB, an EV charging connector, and the standard junction boxes. Each standard junction box can also be connected to an EV charging connector. For an EVSB that can only directly connect to one load at a time, connecting the smart junction box to the EVSB enables multiple vehicles to be connected to the charging system at one time. The smart junction box’s switches switch the electrical connections between the EVSB and each of the smart and standard junction boxes to enable consecutive charging of individual vehicles, so that all vehicles can be charged without requiring manual intervention.

### FIELD OF THE INVENTION

The disclosed concept relates generally to electric vehicle (EV) charging systems, and more particularly, to junction boxes for EV charging systems.

### BACKGROUND OF THE INVENTION

With the development of electric vehicle (EV) technology, the number of EVs is growing rapidly, and demand for residential EV chargers and commercial EV charging stations, similar to gas stations, is significant. A residential EV charger provides a plug point for a user to recharge their EV at home. A commercial EV charging station, also called an electric recharging point, charging point, and EVSE (Electric Vehicle Supply Equipment), is an element in an infrastructure that supplies electric energy for the recharging of electric vehicles, plug-in hybrid electric-gasoline vehicles, or semi-static and mobile electrical units such as exhibition stands. EV charging stations generally consist of a charging base connected to a power supply (e.g. utility power), and a number of chargers/charging connectors connected to the charging base by electrical connector cables. Each charging connector is structured to connect to a charging interface on an EV in order to charge the battery of the EV with power supplied to the charging station.

An EV Smart Breaker (EVSB) is a circuit breaker that is configured to provide charging and circuit protection for an electric vehicle during charging. The combination of a junction box with a connector cable and an EV charging connector (J1772 or NACS, for example and without limitation) can be used as an extension of the EVSB when a vehicle cannot be parked in sufficiently close proximity to the EVSB. In certain use contexts, there may be only a single EVSB available for multiple vehicles that need to be charged, and known junction boxes only enable one vehicle to be connected to the junction box at one time. In this situation, after connecting a first vehicle to the junction box for charging, the user has to check to determine when the first vehicle has finished charging, manually disconnect the first vehicle from the junction box, and then manually connect a second vehicle that needs charging. Users may find this inconvenient, for example and without limitation, in a home having only one EVSB and having two vehicles that need to be charged at night in order to be ready for driving the next morning. In order for both cars to get charged prior to the next morning, a user must be available to check when the first car has finished charging and to disconnect the first car from the junction box and then connect the second EV to the junction box.

There is thus room for improvement in junction boxes for EV charging systems.

### SUMMARY OF THE INVENTION

These needs, and others, are met by embodiments of a smart junction box for use with an EV smart circuit breaker (EVSB). The smart junction box can be used to form an improved EV charging system that includes the smart junction box, the EVSB, and one or more standard junction boxes. The smart junction box comprises multiple switch devices (such as, for example and without limitation, relays or contactors), has communication capability, and is structured to simultaneously be connected to the EVSB, an EV charging connector, and the standard junction boxes. Each standard junction box can also be connected to an EV charging connector. For an EVSB that can only directly connect to one load at a time, connecting the smart junction box as a load to the EVSB enables multiple vehicles to be connected to the charging system at one time. The smart junction box communicates with the EVSB in order to determine when to actuate the switch devices in order to switch the electrical connections between the EVSB and each of the smart and standard junction boxes, thus enabling consecutive charging of individual vehicles, so that all vehicles connected to the system can be charged without requiring manual intervention.

In accordance with one aspect of the disclosed concept, a smart junction box for use in an EV charging system comprises: a plurality of connection ports, a plurality of switch devices, and a communication module. The smart junction box is configured to be simultaneously electrically connected to an EVSB, an EV charging connector, and a number of standard junction boxes via the plurality of connection ports, the number of standard junction boxes not having smart capabilities. The communication module is configured to communicate with the EVSB in order to provide information to the EVSB and receive instructions from the EVSB. The smart junction box is configured to switch the plurality of switch devices in order to close and open electrical connections between the EVSB and each of the EV charging connector and the number of standard junction boxes.

In accordance with another aspect of the disclosed concept, an EV charging system comprises: an EVSB; a number of standard junction boxes, the number of standard junction boxes not having smart capabilities; and a smart junction box. The smart junction box comprises: a plurality of connection ports; a plurality of switch devices; and a communication module. The smart junction box is simultaneously electrically connected to the EVSB and the number of standard junction boxes via the plurality of connection ports and is configured to be further simultaneously electrically connected to and physically coupled to an EV charging connector. The communication module is configured to communicate with the EVSB in order to provide information to the EVSB and receive instructions from the EVSB. The smart junction box is configured to switch the plurality of switch devices in order to close and open electrical connections between the EVSB and each of the EV charging connector and the number of standard junction boxes.

### BRIEF DESCRIPTION OF THE DRAWINGS

A full understanding of the invention can be gained from the following description of the preferred embodiments when read in conjunction with the accompanying drawings in which:

FIG. 1 is a symbolic depiction of a known EV charging network that includes an EV smart breaker (EVSB), a known standard (non-smart) junction box, and a charging connector connected to the known junction box;

FIG. 2 is symbolic depiction of an improved EV charging network that includes an improved junction box that is a smart junction box, in accordance with an example embodiment of the disclosed concept, the improved EV charging network also including a number of standard junction boxes and a plurality of charging connectors connected to the junction boxes;

FIG. 3A is a star configuration of the improved EV charging network of FIG. 2 that includes one smart junction box and multiple standard junction boxes;

FIG. 3B is a sequential configuration of the improved EV charging network of FIG. 2 that includes multiple smart junction boxes in series and optionally includes one standard junction box; and

FIG. 3C is a combination sequential and star configuration of the improved EV charging network of FIG. 2 that combines the configurations shown in FIG. 3A and FIG. 3B.

### DETAILED DESCRIPTION OF THE INVENTION

Directional phrases used herein, such as, for example, left, right, front, back, top, bottom and derivatives thereof, relate to the orientation of the elements shown in the drawings and are not limiting upon the claims unless expressly recited therein.

As employed herein, the statement that two or more parts are “connected” or “coupled” together shall mean that the parts are joined together either directly or joined through one or more intermediate parts, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As employed herein, the term “controller” shall mean a programmable analog and/or digital device that can store, retrieve, and process data; a microprocessor; a microcontroller; a microcomputer; a central processing unit; or any suitable processing device or apparatus.

As employed herein, the term “number” shall mean one or an integer greater than one (i.e., a plurality).

As employed herein, when ordinal terms such as “first” and “second” are used to modify a noun, such use is simply intended to distinguish one item from another, and is not intended to require a sequential order unless specifically stated.

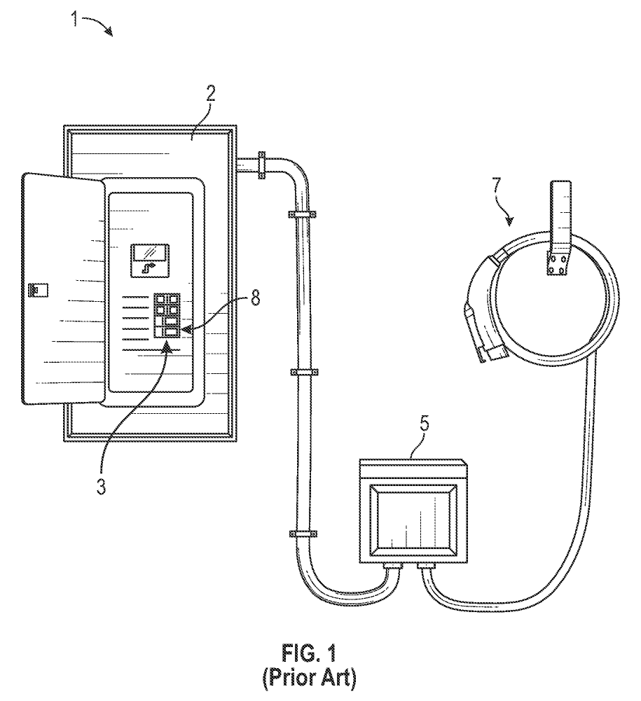

The term “smart” is used herein to denote a device that is capable of communicating and exchanging data with other devices in order to make decisions and act upon those decisions. FIG. 1 shows a known EV charging system 1 comprising a load center 2 with an EV smart circuit breaker 3 (EVSB 3) installed, a known standard junction box 5, and an EV charging connector 7. It is noted that the EVSB 3 can be installed in various different compatible enclosures including but not limited to load centers (such as the load center 2), panel boards, switch boards, etc. The standard junction box 5 does not have smart capabilities. That is, the standard junction box 5 transmits data, but is unable to autonomously make decisions and act upon those decisions.

The standard junction box 5 is electrically connected to the EVSB 3, and the EV charging connector 7 is electrically connected to the standard junction box 5 and structured to interface with an electric vehicle (not shown) in order to charge the EV battery. The EVSB 3 is connected to a power supply (not shown), and the EV charging connector 7 receives power from the power supply through the standard junction box 5 and the EVSB 3. The standard junction box 5 is the first connection on the load side of the EVSB 3 and serves as an extension of the EVSB 3, to enable a vehicle to be parked farther away from the EVSB 3 and still electrically connect to the EVSB 3. As previously noted, the standard junction box 5 is non-smart and simply transmits data from the EVSB 3 to the EV charging connector 7 or vice versa, and executes commands received by the EVSB 3 or the EV charging connector 7. The EVSB 3 includes an internal contactor 8 (not visible in the figures) that gets actuated in order to switch the power provided by the power supply.

The EVSB 3, and the standard junction box 5 by extension, provides circuit tripping functionality in the event that the electrical connection between the power supply and the vehicle being charged exceeds the safety rating of any components connected within the EV charging system 1. For example and without limitation, the EVSB 3 provides thermal-magnetic protection, ground fault protection, automatic and remote control of the internal contactor 8 so that no user interaction is needed, instructs a vehicle how much current to draw to keep from overloading the circuit, and protects users with interlocked power so that power is never available at the EV charging connector 7 unless it is plugged into an electric vehicle. It is noted that the smart capability (i.e. the communication and decision-making capability) of the EVSB 3 is what allows different EV charging connectors 7 to be connected and disconnected from the EVSB 3, as a non-smart EV charging device would have one dedicated charging connector 7 having a fixed connection to the non-smart EV charging device.

The standard junction box 5 is structured to enable only one EV charging connector 7 to connect to the standard junction box 5 at a time. The practical effect of this is that only one electric vehicle can be electrically connected to the EVSB 3 at a time, such that, if there is more than one electric vehicle that needs to be charged and a first vehicle is plugged into the standard junction box 5, a user must manually unplug the first vehicle so that the second vehicle can then be manually plugged into the standard junction box 5. It is further noted that the EVSB 3 is structured to be directly connected to only one load at a time, i.e., the load side of the EVSB 3 can only be directly connected to one standard junction box 5 or to one electric vehicle at any given time.

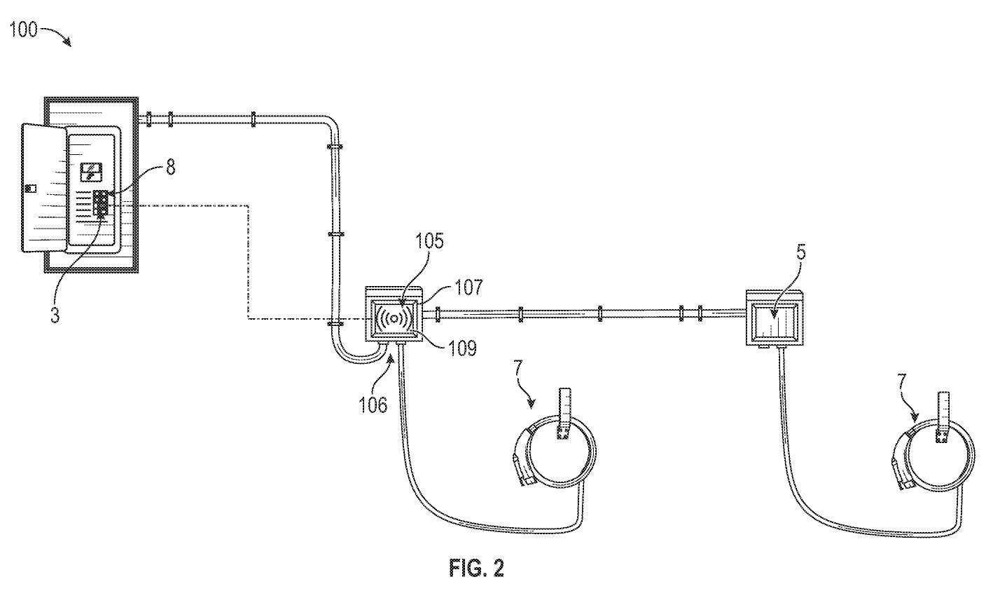

FIG. 2 shows an improved EV charging system 100 that comprises an improved junction box that is a smart junction box 105, disclosed in accordance with an example embodiment of the disclosed concept. The EV charging system 100 also comprises the EVSB 3 and the non-smart standard junction box 5 that are included in the known EV charging system 1. However, in contrast with the known EV charging system 1, in the improved EV charging system 100 the disclosed smart junction box 105 is the first connection on the load side of the EVSB 3, and the standard junction box 5 is connected on a load side of the smart junction box 105.

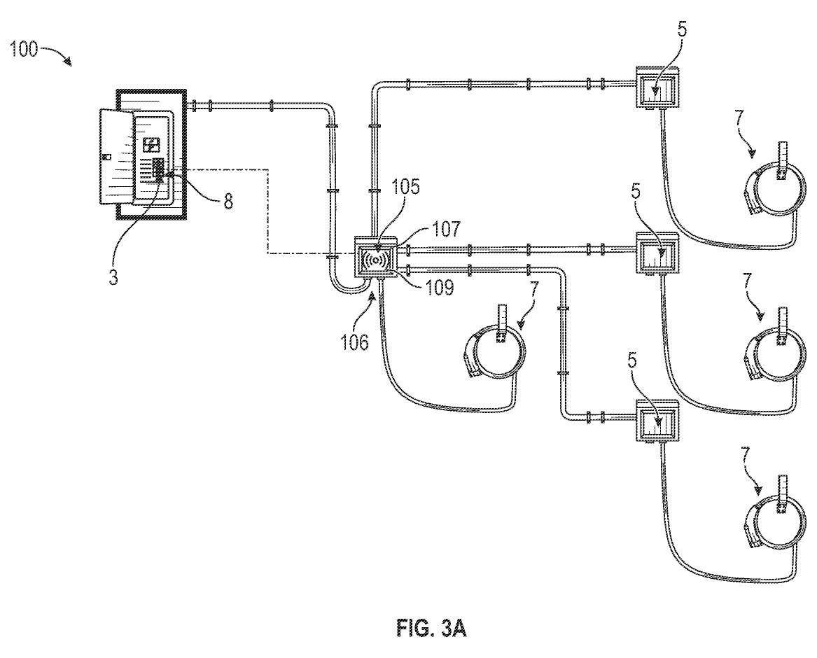

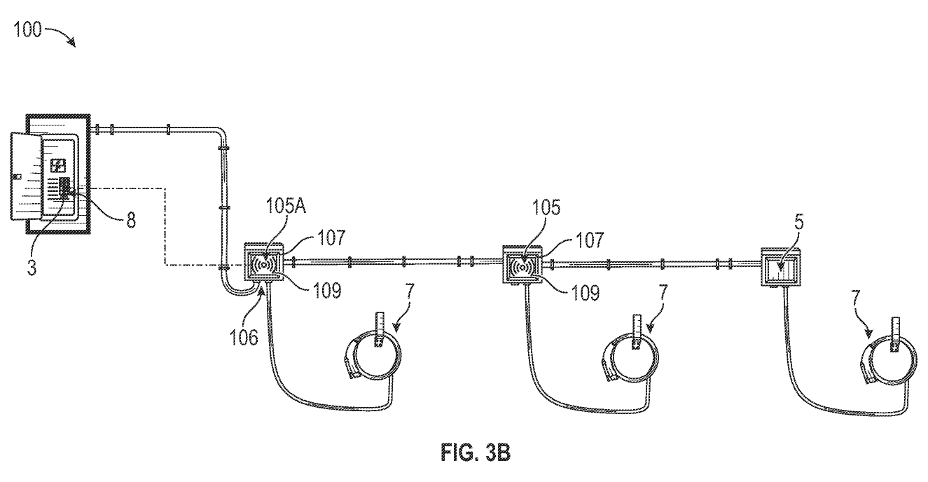

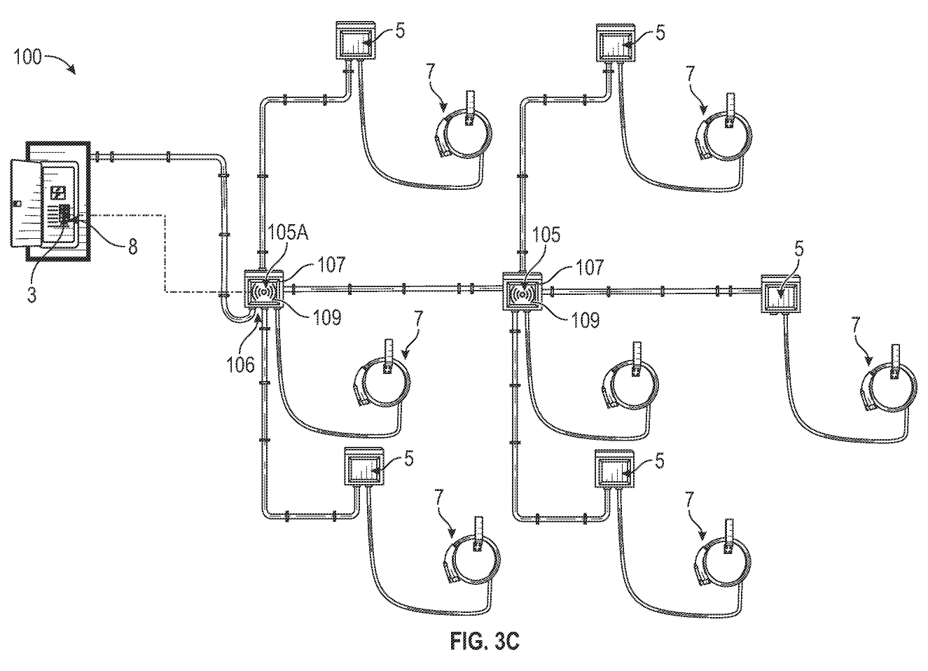

The smart junction box 105 comprises a plurality of connection ports 106, and is structured to connect to the EVSB 3, to a number of the standard junction boxes 5, and to an EV charging connector 7 via each of the connection ports 106. While the smart junction box 105 is depicted in FIG. 2 as being connected to just one of the standard junction boxes 5, the smart junction box 105 can be structured to connect to more than one of the standard junction boxes 5 at a time in addition to connecting to the EVSB 3, as shown in FIG. 3A and FIG. 3C, detailed further later herein. That is, the smart junction box 105 can be produced with a greater number of connection ports 106 in order to accommodate connections to additional standard junction boxes 5, if desired. The smart junction box 105 can also be connected to one or more additional smart junction boxes 105 in series, with one standard junction box 5 optionally being the last junction box connected in the series, as shown in FIG. 3B and FIG. 3C, detailed further later herein. For the sake of simplicity, the improved EV charging system 100 is primarily discussed hereinafter as having only one standard junction box 5 connected to the smart junction box 105.

The EVSB 3 outputs L1 (line 1), L2 (line 2), and G (ground) signals for EV charging, which are standard high current signals provided by an EV charging device. In the known EV charging system 1, the standard junction box 5 simply conducts these signals to the EV connector 7 and conducts signals transmitted by the EV connector 7 to the EVSB 3. For example and without limitation, the EVSB 3 can be rated for use in either a relatively low current range or a relatively high current range, and when the EVSB 3 is rated for a relatively low current range, one non-limiting illustrative example of a signal that can be output by the EV connector 7 is a control pilot signal, which is a low voltage PWM signal that simply identifies the EV connector 7 as being either a 40 amp or 30 amp charger to a connected electric vehicle. The smart junction box 105 has all of the capabilities of the standard junction box 5 and also has the additional capability of being able to switch the L1/L2/G signals between itself and the standard junction box 5 via switch devices 107 (not visible in the figures) included in the smart junction box 105. Each switch device 107 can comprise, for example and without limitation, a relay or a contactor. As such, the improved EV charging system 100 can have as many electric vehicles plugged into the system 100 as there are junction boxes 105, 5. That is, every junction box 105 or 5 in the improved EV charging system 100 can have one electric vehicle plugged into it.

The smart junction box 105 additionally includes a communication module 109 that enables the smart junction box 105 to communicate with the EVSB 3 through either a wired or a wireless connection. This communication capability enables the smart junction box 105 and the EVSB 3 to communicate with each other and to coordinate switching the charging connection from being between the EVSB 3 and a first of the junction boxes 105, 5 (and its connected vehicle) to being between the EVSB 3 and a second of the junction boxes 105, 5 (and its connected vehicle).

FIG. 3A depicts a star configuration of the improved EV charging system 100. In this configuration, the EV charging system 100 includes one smart junction box 105 and a plurality of standard junction boxes 5. In the star configuration, each standard junction box 5 is directly connected to the load side of the smart junction box 105. This requires that the entirety of the switching scheme for the improved EV charging system 100 be implemented in the smart junction box 105 so that the smart junction box 105 can route power to any of the standard junction boxes 5, thus leading to the wiring being in the star configuration.

FIG. 3B depicts a sequential configuration of the improved EV charging system 100. The wiring required for the sequential configuration is simpler than that required for the star configuration. In the sequential configuration, the EV charging system 100 includes a plurality of smart junction boxes 105 connected in series and optionally includes one standard junction box 5 that is the last entity to be to be connected in series with the plurality of smart junction boxes 105. That is, in the sequential configuration of the EV charging system 100, the system 100 includes one standard junction box 5, and the standard junction box 5 must be the last entity in the series connection, i.e. the entity connected furthest away from the EVSB 3. In the sequential configuration, the smart junction box 105 that is directly connected to the load side of the EVSB 3 can be designated as the primary smart junction box 105A. A second smart junction box 105 is directly connected to the load side of the primary junction box 105A, and each additional junction box 105, 5 is directly connected to the load side of the smart junction box 105 directly upstream. When any given junction box 105, 5 downstream of the primary smart junction box 105A needs to receive power in order to charge a connected vehicle, all smart junction boxes 105 upstream of the given junction box 105, 5 communicate with each other to route power to the given junction box 105, 5.

FIG. 3C depicts a combination sequential and star configuration, referred to hereinafter as the “combination configuration” of the improved EV charging system 100. The combination configuration starts with the sequential configuration of FIG. 3B, and then any of the smart junction boxes 105, 105A in the sequential configuration can be wired to a plurality of standard junction boxes 5 in the star configuration of FIG. 3A.

It will be appreciated that the inclusion of the smart junction box 105 in the smart EV charging system 100 provides an improvement over the known EV charging system 1, because multiple vehicles can be plugged into the EV charging system 100 at one time, i.e. one vehicle can be directly plugged in to the smart junction box 105 and one additional vehicle can be plugged in to every junction box 5, 105 that is connected to the first smart junction box 105, 105A directly connected to the load side of the EVSB 3. The terms “plugged in” and “directly plugged in”, when used herein to describe a vehicle being plugged in to one of the junction boxes 105, 5, is used to denote that the vehicle is interfacing with a charging connector 7 that is directly physically coupled (and thus also electrically connected) via its cable to the junction box 105, 5. In the interest of thoroughness, it is noted that in the improved EV charging system 100, it is possible for there to be no vehicle directly plugged in to the first smart junction box 105, 105A directly connected to the load side of the EVSB 3 while one or more of the downstream junction boxes 5, 105 has a vehicle plugged in, and the first smart junction box 105, 105A will facilitate charging of the vehicle(s) plugged in to the one or more downstream junction boxes 5, 105.

While the EVSB 3 is capable of only charging a single vehicle at a time, the smart junction box 105 enables multiple vehicles to be connected to the system 100 at one time, since the smart junction box 105 facilitates automated switching between the EVSB 3 and each of the vehicles in the system 100 that needs to be charged. The smart junction box 105 thus eliminates the need for a user to be available to manually unplug a charged vehicle and plug in another vehicle that needs to be charged, because the smart junction box 105 ensures that all vehicles connected to the improved system 100 will be consecutively charged. In one non-limiting illustrative example, for two working family members who each have a vehicle that needs to be charged at night after the work day for use the next morning, the improved EV charging system 100 enables both family members to plug their cars in to the EV charging system 100 at the same time and have the assurance that both of their vehicles will be charged in the morning, without requiring one of them to wake up during the night or interrupt leisure time to unplug the first vehicle and plug in the second. The improved EV charging system 100 also eliminates the risk that a user will forget to unplug the first vehicle after it has charged and plug in the second vehicle.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A smart junction box for use in an EV charging system, the smart junction box comprising:
a plurality of connection ports;
a plurality of switch devices; and
a communication module,
wherein the smart junction box is configured to be simultaneously electrically connected to an EVSB, an EV charging connector, and a number of standard junction boxes via the plurality of connection ports, the number of standard junction boxes not having smart capabilities,
wherein the communication module is configured to communicate with the EVSB in order to provide information to the EVSB and receive instructions from the EVSB, and
wherein the smart junction box is configured to switch the plurality of switch devices in order to close and open electrical connections between the EVSB and each of the EV charging connector and the number of standard junction boxes.

2. The smart junction box of claim 1,
wherein the smart junction box is configured to transmit signals output by the EVSB to any of the number of standard junction boxes and to transmit signals output by any of the number of standard junction boxes to the EVSB.

3. The smart junction box of claim 1,
wherein the smart junction box is structured to have each standard junction box in the number of standard junction boxes be directly connected to a load side of the smart junction box.

4. The smart junction box of claim 1,
wherein the smart junction box is designated as a primary smart junction box and is configured to be further simultaneously electrically connected to a second smart junction box via one connection port in the plurality of connection ports, the second smart junction box having one standard junction box electrically connected at a load side of the second smart junction box, and
wherein the primary smart junction box is configured to communicate
with the second smart junction box in order to supply power to the one standard junction box.

5. An EV charging system, the EV charging system comprising:
an EVSB;
a number of standard junction boxes, the number of standard junction boxes not having smart capabilities; and
a smart junction box, the smart junction box comprising:
a plurality of connection ports;
a plurality of switch devices; and
a communication module,
wherein the smart junction box is simultaneously electrically connected to the EVSB and the number of standard junction boxes via the plurality of connection ports and is configured to be further simultaneously electrically connected to and physically coupled to an EV charging connector,
wherein the communication module is configured to communicate with the EVSB in order to provide information to the EVSB and receive instructions from the EVSB, and
wherein the smart junction box is configured to switch the plurality of switch devices in order to close and open electrical connections between the EVSB and each of the EV charging connector and the number of standard junction boxes.

6. The EV charging system of claim 5,
wherein the smart junction box is physically coupled to and electrically connected to the EV charging connector.

7. The EV charging system of claim 6,
wherein at least one standard junction box in the number of standard junction boxes is connected to an additional EV charging connector.

8. The EV charging system of claim 5,
wherein, for one standard junction box and at least one other standard junction box in the number of standard junction boxes, the one standard junction box and the at least one other standard junction box are directly connected to a load side of the smart junction box.

9. The EV charging system of claim 8,
wherein the smart junction box is configured to transmit signals output by the EVSB to any of the number of standard junction boxes and to transmit signals output by any of the number of standard junction boxes to the EVSB.

10. The EV charging system of claim 8,
wherein at least one of the one standard junction box and the at least one other standard junction box is physically coupled and electrically connected to another EV charging connector.

11. The EV charging system of claim 5,
wherein the smart junction box is designated as a primary smart junction box and is further simultaneously electrically connected at a load side to a second smart junction box, the second smart junction box having one standard junction box electrically connected at a load side of the second smart junction box, and
wherein the primary smart junction box is configured to communicate with the second smart junction box in order to supply power to the one standard junction box.

12. The EV charging system of claim 11,
wherein the primary smart junction box is further simultaneously electrically connected to a third smart junction box, the third smart junction box being directly connected to a load side of the primary smart junction box,
wherein the second smart junction box is directly connected to a load side of the third smart junction box,
wherein the primary smart junction box, the second smart junction box, and third smart junction box are configured to route power to any of the second smart junction box, the third smart junction box, and the standard junction box that require power.

13. The EV charging system of claim 11,
wherein at least one of the primary smart junction box and the second smart junction box has a plurality of standard junction boxes directly connected to the load side of the at least one of the primary smart junction box and the second smart junction box.

14. The EV charging system of claim 12,
wherein at least one of the primary smart junction box, the second smart junction box, and the third smart junction box has a plurality of standard junction boxes directly connected to the load side of the at least one of the primary smart junction box, the second smart junction box, and the third smart junction box.
